(19) United States
(12) Patent Application Publication
(10) Pub. No.: US 2009/0154591 A1
(43) Pub. Date: Jun. 18, 2009

(54) High-speed serial data signal transmitter driver circuitry

(75) Inventors: Wilson Wong, San Francisco, CA (US); Allen Chan, San Jose, CA (US); Sergey Shumarayev, Los Altos Hills, CA (US); Weiqi Ding, Fremont, CA (US)

Correspondence Address: ROPES & GRAY LLP, PATENT DOCKETING 39/361, 1211 AVENUE OF THE AMERICAS, NEW YORK, NY, 10036-8704, US

(73) Assignee: Altera Corporation

(21) Appl. No.: 12/002,540

(22) Filed: Dec. 17, 2007

(51) Int. Cl. H04L 27/00

(52) U.S. Cl. 375/295

(57) ABSTRACT

Transmitter driver circuitry for outputting a high-speed serial data signal (e.g., in the range of about 10 gigabits per second or higher) includes H-tree driver circuitry having only a main driver stage and a post-tap driver stage. At least one transistor in the H-tree driver circuitry is constructed and connected to provide electrostatic discharge protection. PMOS and NMOS current sources are used for the H-tree driver circuitry to enhance power supply noise rejection.

### BACKGROUND OF THE INVENTION

This invention relates to integrated circuitry, and more particularly to high-speed, serial, digital, data signal transmitter driver circuitry for use on integrated circuit devices.

High-speed serial data signalling is increasingly of interest for such purposes as sending data between the various integrated circuits that make up a system on a printed circuit board. Higher data rates for such signalling are always being sought, but such higher dates are increasingly difficult to attain. Interest is currently focused on data rates in the range of about 10 gigabits per second (10 Gpbs) and higher. At these data rates, great care must be given to how the signal is transmitted by transmitter circuitry so that the inevitable attenuation/distortion/etc. of the signal as it passes through the communication medium to the receiver circuitry does not make the information carried by the signal unrecoverable by the receiver.

### SUMMARY OF THE INVENTION

In accordance with certain aspects of the invention, transmitter driver circuitry for outputting a high-speed serial data signal (e.g., in the range of about 10 gigabits per second or higher) includes H-tree driver circuitry having only a main driver stage and a post-tap driver stage. Preferably, at least one transistor in the H-tree driver circuitry is constructed and connected to provide electrostatic discharge protection for the circuit. Preferably also, PMOS and NMOS current sources are used for the H-tree driver circuitry to enhance power supply noise rejection.

Further features of the invention, its nature and various advantages, will be more apparent from the accompanying drawings and the following detailed description.

### BRIEF DESCRIPTION OF THE DRAWINGS

FIG. 1 is a simplified schematic block diagram of an illustrative embodiment of circuitry constructed in accordance with the invention.

FIG. 2 is a simplified functional or operational diagram showing the overall function or operation of the FIG. 1 circuitry.

FIG. 3 is a simplified block diagram showing transmitter circuitry of the type shown in FIG. 1 connected via illustrative transmission medium circuitry to illustrative receiver circuitry.

FIG. 4 is similar to FIG. 3 for a different type of circuitry that is not part of the invention.

FIG. 5 is a simplified schematic diagram showing a representative transistor structure from FIG. 1 with aspects of that structure being used in a particular way in accordance with a possible aspect of the invention.

FIG. 6 is a simplified cross-sectional view of illustrative integrated circuit structure of the type that is shown schematically in FIG. 5.

FIG. 7 is a simplified schematic diagram showing another representative transistor structure from FIG. 1 with aspects of that structure being used in a particular way in accordance with another possible aspect of the invention.

FIG. 8 is a simplified cross-sectional view of illustrative integrated circuit structure of the type that is shown schematically in FIG. 7.

FIG. 9 is a simplified schematic diagram showing a representative current source structure from FIG. 1 in accordance with certain possible aspects of the invention.

FIG. 10 is a simplified block diagram showing an illustrative embodiment of additional circuitry that may be used with circuitry of the type shown in FIG. 1 in accordance with the invention.

### DETAILED DESCRIPTION

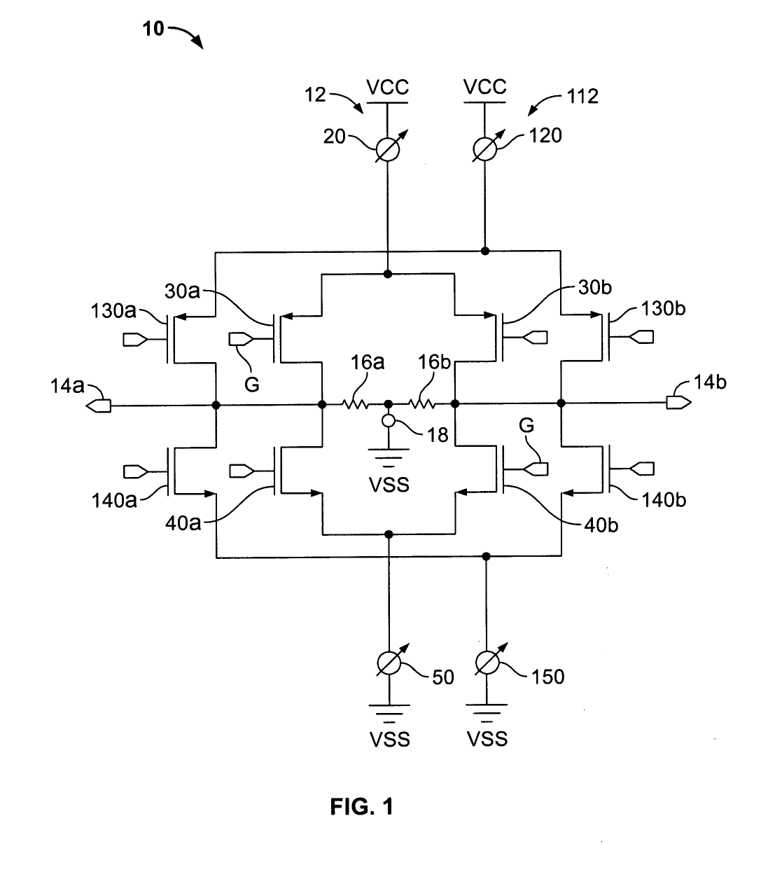

An illustrative embodiment of serial data signal transmitter driver circuitry 10 in accordance with this invention is shown in FIG. 1. Circuitry 10 is two-stage driver circuitry. These two stages are a main (or main tap) driver stage 12 including elements 20, 30a, 30b, 40a, 40b, and 50; and a post (or post tap) driver stage 112 including elements 120, 130a, 130b, 140a, 140b, and 150. Each of stages 12 and 112 is a differential driver stage that is connected to output terminals 14a and 14b across a pair of voltage dividing resistors 16a and 16b. For example, each of resistors 16 may be a 50 ohm resistor. The node between resistors 16a and 16b is connected to ground (VSS) via voltage source 18. (Another term for “ground” is a source of ground voltage or ground potential.)

The elements of main driver stage 12 are current source 20 connected in series between power supply voltage or potential source VCC and the source terminals of PMOS transistors 30a and 30b, PMOS transistor 30a having its source-drain path connected in series between current source 20 and output terminal 14a, PMOS transistor 30b having its source-drain path connected in series between current source 20 and output terminal 14b, NMOS transistor 40a having its source-drain path connected in series between output terminal 14a and current source 50, NMOS transistor 40b having its source-drain path connected in series between output terminal 14b and current source 50, and current source 50 connected in series between the source terminals of transistors 40a and 40b and VSS.

The elements of post driver stage 112 are current source 120 connected in series between power supply voltage source VCC and the sources of PMOS transistors 130a and 130b, PMOS transistor 130a having its source-drain path connected in series between current source 120 and output terminal 14a, PMOS transistor 130b having its source-drain path connected in series between current source 120 and output terminal 14b, NMOS transistor 140a having its source-drain path connected in series between output terminal 14a and current source 150, NMOS transistor 140b having its source-drain path connected in series between output terminal 14b and current source 150, and current source 150 connected in series between the drains of transistors 140a and 140b and VSS.

The digital (i.e. binary) serial data signal to be transmitted is applied to the gate G of transistors 30a and 40a. (Only the gates of these transistors are labelled G. It will be understood from this representative use of reference character G where the gates of all other transistors are.) This may be referred to as the “true” form or version of the data signal. The complement or inverse of the data signal is applied to the gates of transistors 30b and 40b. A delayed and inverted version of the data signal is applied to the gates of transistors 130a and 140a. The amount of this delay may be, for example, one unit interval of the data signal (a unit interval being the time duration of one data bit in the serial data signal). Alternatively, the delay may be more or less than one unit interval, but it will generally be assumed herein that the delay is one unit interval. The complement or inverse of the delayed and inverted data signal is applied to the gates of transistors 130b and 140b.

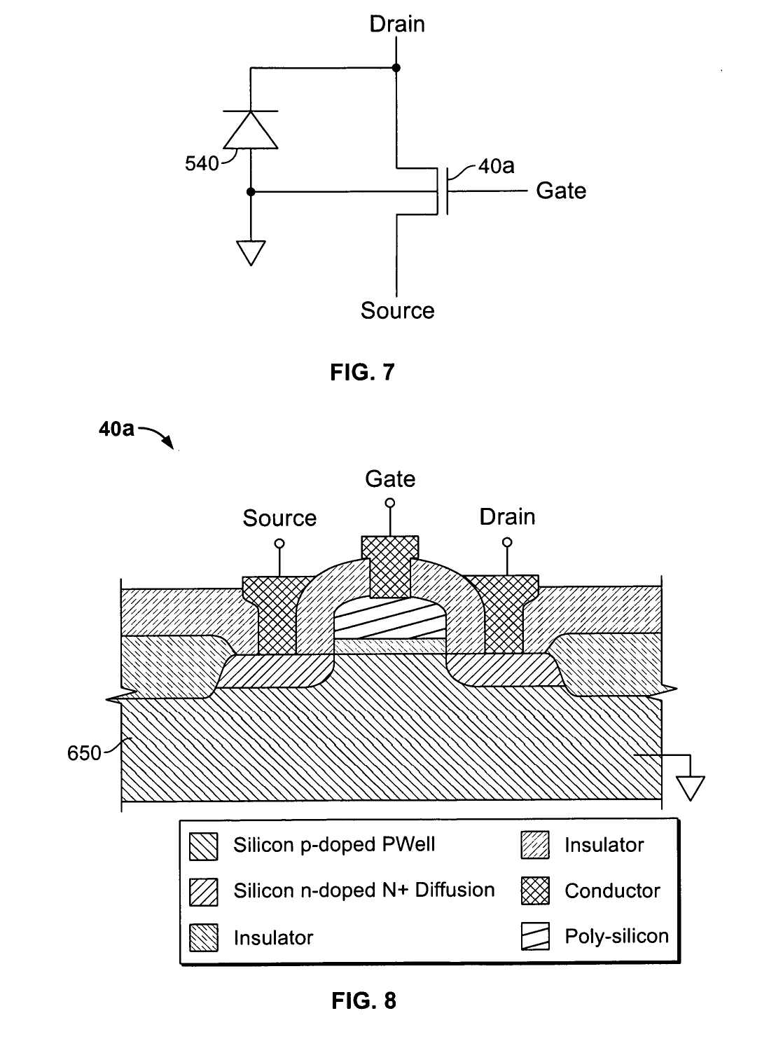

The strengths of current sources 20, 120, 50, and 150 is shown as variable. By “strength” it is meant that the amount of current that flows through these current sources is controllably variable. For example, the user of circuitry 10 may be able to adjust the strength of each current source. If circuitry 10 is used on a programmable integrated circuit such as a programmable microcontroller or a programmable logic device, the user of the circuit may be able to program configuration memory elements (e.g., 600 in FIG. 7) of the integrated circuit to control (select) the strengths of current sources. This gives the current sources relatively static strengths. Alternatively, more dynamic (i.e., time-varying) signals may be used to control the strengths of current sources 20, 120, 50, and/or 150. For example, such dynamic control signals may come from circuitry that automatically monitors and analyzes the performance of the communication link that includes transmitter 10, and that automatically adjusts current source strength in an effort to improve the performance of that link.

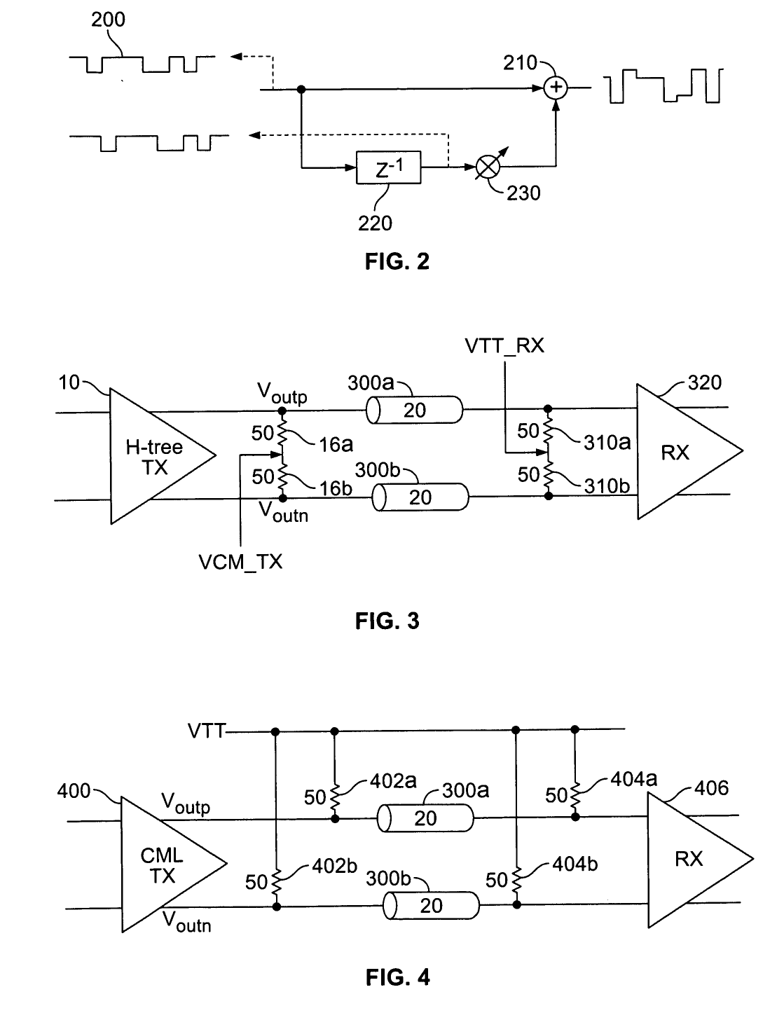

From the foregoing it will be seen that transmitter driver circuit 10 superimposes the delayed and inverted (“post”) version of the data signal on the main (undelayed) version of that signal. The amplitude of the delayed and inverted version that is thus superimposed is typically less than the amplitude of the undelayed version. This is done to give the signal leaving the transmitter what is sometimes called pre-emphasis. Pre-emphasis is used to help counteract attenuation/distortion/etc. of the signal as it travels from the transmitter to the receiver. FIG. 2 shows in somewhat more abstract terms the operation of this pre-emphasis digital filter. The data signal to be transmitted is shown at 200 (an illustrative data stream having a typical pattern). This signal is applied to one input terminal of analog adder 210. Element 220 delays the data signal by one unit interval. Element 230 scales (adjusts the amplitude of) and inverts the output signal of element 220 and applies the result to the other input terminal of adder 210. Adder 210 combines its two inputs, and outputs the result as the transmitter output signal 240.

Element 220 corresponds to the delay between the data signal applied to main driver stage 12 in FIG. 1 and the delayed and inverted data signal applied to post driver stage 112 in that FIG. Adder 210 corresponds to the fact that main driver stage 12 and post driver stage 112 are connected in parallel with one another to output terminals 14a and 14b in FIG. 1. Element 230 corresponds to the ability in FIG. 1 to adjust the drive strength of main and post stages 12 and 112 relative to one another by adjusting the strengths of current sources 20 and 50 relative to the strengths of current sources 120 and 150.

At the extremely high serial data rates that are of interest in connection with this invention (i.e., at data rates in the range of about 10 Gbs and higher), it is very important to keep the loading of the transmitter driver circuitry “light” (i.e., small). In other words, the transmitter driver circuitry should not unduly load (e.g., capacitively load) output terminals 14a and 14b. Such loading reduces the ability of the circuitry to rapidly switch from high to low and vice versa as is required to transmit data at the extremely high data rates mentioned above. To avoid such undue loading of the output terminals, transmitter driver 10 has only two driver stages 12 and 112. No other driver stages are permitted to be connected to output terminals 14a and 14b because any such further driver stages would increase the loading on the output terminals.

In order to perform satisfactorily at data rates like those mentioned above, transmitter driver 10 should have good electrostatic discharge (“ESD”) protection, low output pin capacitance, high data rate (in the range mentioned above), low electromagnetic interference (“EMI”) generation, good power supply noise rejection, and low power consumption. To meet these requirements, driver 10 uses an H-tree driver topology with pre-emphasis (FIG. 2 showing the pre-emphasis path and waveform for one post tap pre-emphasis as described earlier in this specification). The following further explains how driver 10 meets the requirements set forth above.

Transmitter driver 10 has a minimal number of taps (i.e., only main tap 12 and post tap 112) to reduce loading and meet S11 requirements (i.e., the scattering parameter or return loss (reflected energy)). Transmitter driver 10 also includes a simplified resistor termination scheme (i.e., resistors 16a and 16b; simplified as compared, for example, to calibrated termination schemes). Again, this simplified resistor termination scheme reduces loading and helps to meet S11 requirements.

Another attribute of transmitter driver 10 is its ability to allow selection of the differential output voltage (“Vod”), i.e., the voltage swing between output terminals 14a and 14b when the driver switches from signalling one binary output value (e.g., binary 0) to signalling the other binary output value (e.g., binary 1). (As in any differential output driver, the signals at the two output terminals 14a and 14b are always complementary (logically inverse) to one another.) For a given value of resistors 16a and 16b (e.g., 50 ohm each), Vod is determined (primarily) by the strength of current sources 20 and 50. These two current sources are typically always given the same strength, but that strength is preferably controllably variable as mentioned earlier in this specification. For example, the strength of each of current sources 20 and 50 may be variable from 2 mA to 8 mA (e.g., to allow Vod to be varied from 200 mV to 800 mV). As mentioned earlier, this control of current source strength may be programmable.

Post-tap driver stage 112 may be similarly controllable in strength (e.g., from 0.25 mA to 6 mA in 0.25 mA increments in terms of the strength of each of current sources 120 and 150).

H-tree driver 10 has dynamic performance on a par with a CML driver. However, H-tree driver 10 has the additional benefits of inherent symmetry, better power supply noise rejection, and much lower power consumption. The symmetry of the H-tree driver reduces common mode noise and reduces EMI. (“Symmetry” refers to the fact that driver 10 has current sources on both the top (20/120) and bottom (50/150).) The symmetry is due to the use of a current source in both the charge (sources 20 and 120) and discharge (sources 50 and 150) paths. The current source (20 and 120) in the charge path also leads to better power supply (VCC) noise rejection, since the current source provides a high-impedance path of over 10 Kohms to the supply (VCC), as compared to the 50 ohm load used by a typical CML driver.

H-tree driver 10 uses half the static current compared to a typical CML driver. FIG. 3 shows an H-tree link, while FIG. 4 shows a CML link. The peak-to-peak differential output voltage for the H-tree driver (FIG. 3) is

Vodp2p(H-tree)=2*I*50 ohms.

In contrast, the peak-to-peak differential output voltage for the CML driver (FIG. 4) is

Vodp2p(CML)=2*I*25 ohms.

As seen in FIG. 3, the current for the H-tree circuit flows from the positive arm into the negative arm across the load (i.e., the 50 ohm resistor pair 16a/16b at the transmitter and the 50 ohm resistor pair 310a/310b at the receiver 320, which is at the far end of communication link 300a/300b.) The CML output is generated only by one arm, while the other arm is tri-stated. Thus twice the amount of current is required in order to generate the same amount of swing. (In the CML link (FIG. 4), both communication paths 300a and 300b are pulled up with resistors 402a/404a or 402b/404b, while both paths are pulled down by current sources in CML transmitter driver 400. The CML driver is therefore not symmetrical, and current is being drawn through four parallel 50 ohm resistors 402 and 404 at all times, rather than being drawn through two parallel 100 ohm resistor networks 16 and 310 as in the H-tree link shown in FIG. 3.)

Dynamic performance of the H-tree link (FIG. 3) is on a par with the CML driver (FIG. 4) because the dynamic current is the same for both links. In both links the termination impedance seen by each output is the same (for the H-tree, the common mode (between resistors 16) is a virtual ground). The main speed difference comes from any difference in loading. In both designs the loading is due mainly to on-chip routing metalization and the on-chip bump, as well as package parasitics. In the CML layout, the routing loading to the pad is similar to the H-tree. This is because electromigration rules require that the routing must be twice as wide to support twice the static current. Additionally, the transistor or device loading is roughly the same. The CML driver requires an explicit ESD protection device to protect against ESD strikes, while the H-tree design uses the existing PMOS switch transistor and an associated N-well diode to clamp the output against positive strikes. This last point is explained more fully in the next section of this specification.

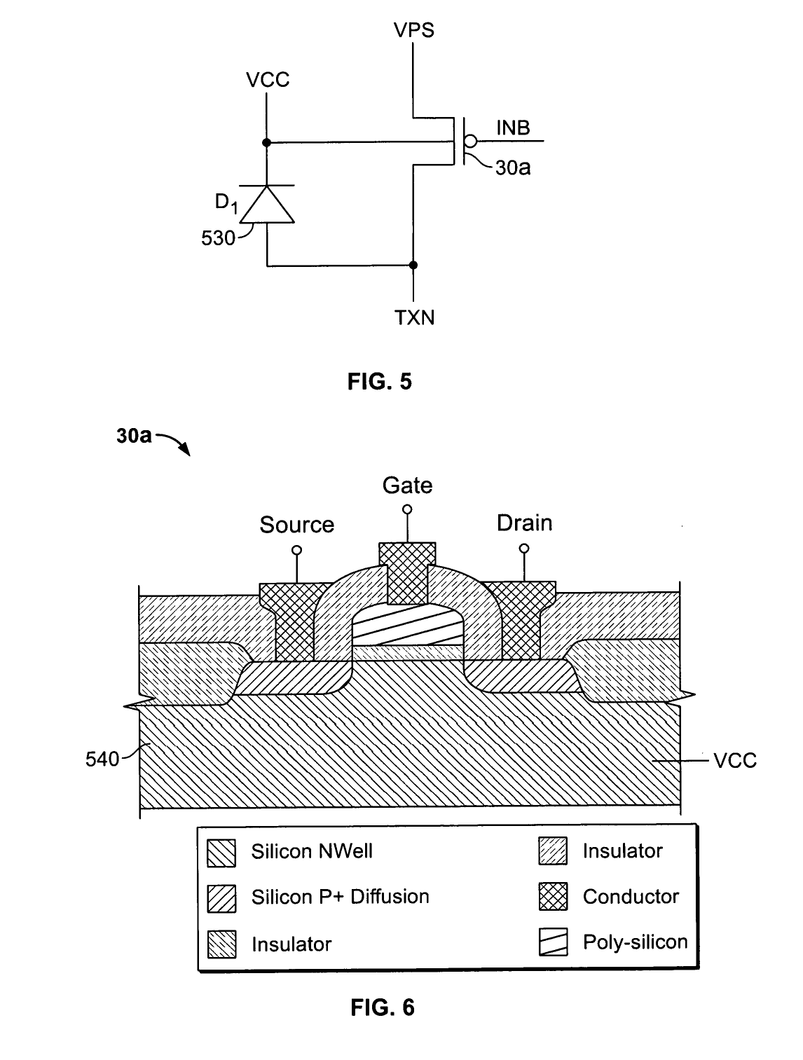

FIGS. 5 and 6 illustrate how a PMOS switch like 30a can be used to provide ESD protection in accordance with the invention. As shown in FIG. 5, diode 530 is a parasitic diode associated with representative PMOS transistor 30a from FIG. 1. FIG. 6 is a cross-section of the integrated circuit structure used to make PMOS transistor 30a. The drain terminal in FIG. 6 is connected to VPS in FIG. 5. The bulk 540 is an N-well, which, in accordance with the present invention, is connected to power (VCC) instead of to the source (which is typically done by others to reduce the body effect.). N-well bulk 540 thus creates a parasitic P-N junction or diode (530 in FIG. 5) with the anode at pin TXN and the cathode at node VCC. This arrangement avoids the need to use a separate, explicit ESD structure to meet ESD requirements. Such a separate ESD structure would add loading to the transmitter driver output terminals, which would degrade performance of the driver. Data rates in the range of 10 Gbps and above require light loading of the output driver terminals. Once again, to be absolutely clear, diode 530 in FIG. 5 represents a parasitic diode that is part of the structure of PMOS transistor 30a. It is not a separately fabricated diode in the integrated circuit device. All of PMOS transistors 30 and 130 can be constructed as shown in FIGS. 5 and 6.

The bulk of one or more NMOS transistors (e.g., 40a) in output driver 10 can also be fabricated for enhanced ESD protection (see FIGS. 7 and 8). This can be done by connecting the bulk 650 of such an NMOS transistor to ground, which also provides a reverse-biased diode 540 from the output pin of driver 10 (at the drain terminal shown in FIG. 7) to ground.

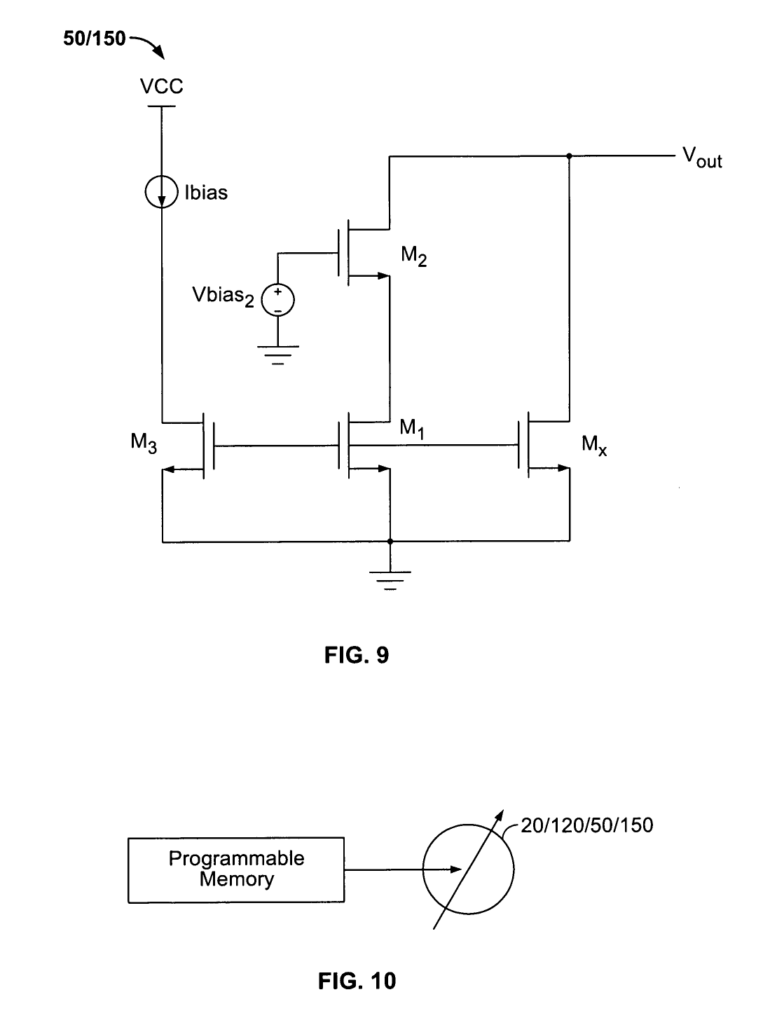

In accordance with certain aspects of the invention, it is preferred to use PMOS and NMOS current sources for elements 20/120 and 50/150, respectively, in transmitter driver 10 (FIG. 1). Such current sources improve power supply noise rejection. In particular, cascode current sources are preferred to improve the output impedance and hence improve power supply noise rejection. This extra level of noise rejection is highly desirable for data rates in the range of 10 Gbps and above. At lower data rates it may be possible not to use such a cascode structure. An illustrative NMOS cascode current source 50/150 is shown in FIG. 9. (By itself, the circuitry shown in FIG. 9 is known.) In this FIG., transistor M2 is a cascode transistor. For NMOS (like FIG. 9) the cascode transistor is usually put in series with the actual current source transistor M1. The bias is determined to allow good headroom. The vout terminal is connected to the source terminals of the NMOS switching transistors 40 or 140 in transmitter driver 10. Cascoding improves output impedance. This is also done for PMOS in a complementary fashion. The current source can be thought of as a composite of the cascode transistor (e.g., M2) and the current source transistor (e.g., M1). A simple current source does not have the extra M2 transistor and includes only the M1 transistor. Its output impedance is substantially smaller.

FIG. 10 shows an illustrative embodiment of how the variable current strength of any one or more of current sources 20/120/50/150 may be controlled. In FIG. 10 a programmable memory 700 is provided on the integrated circuit device that includes transmitter driver 10. Memory 700 can be programmed (e.g., by a user of the device) to store one or more values for controlling the strength of the current provided by one or more of current sources 20, 120, 50, and/or 150. For example, the values stored in memory 700 may allow current strength to be selected from among the various current value options mentioned earlier in this specification.

It will be understood that the foregoing is only illustrative of the principles of the invention, and that various modifications can be made by those skilled in the art without departing from the scope and spirit of the invention. For example, the various current strength options mentioned above for current sources 20, 120, 50, and 150 are only illustrative, and other current strength options can be made available if desired.

What is claimed is:

1. Transmitter driver circuitry for outputting a high speed serial data signal having a serial bit rate in the range of about 10 Gbps comprising:
H-tree driver circuitry having only a main driver stage and a post-tap driver stage.

2. The circuitry defined in claim 1 wherein at least one transistor that forms part of the H-tree driver circuitry additionally provides electrostatic discharge protection for the circuitry.

3. The circuitry defined in claim 2 wherein the at least one transistor is a PMOS transistor whose bulk is connected to a power supply voltage source of the circuitry.

4. The circuitry defined in claim 2 wherein the at least one transistor is an NMOS transistor whose bulk is connected to a source of ground potential of the circuitry.

5. The circuitry defined in claim 1 further comprising:
PMOS current sources for connecting each of the stages to a power supply voltage source of the circuitry; and
NMOS current sources for connecting each of the stages to a source of ground potential of the circuitry.

6. The circuitry defined in claim 5 wherein each of the current sources is controllable with respect to strength of current supplied by that current source.

7. The circuitry defined in claim 6 further comprising:
programmable control elements for controlling the strength of the current supplied by each of the current sources.

8. High-speed serial data signal transmitter driver circuitry comprising:
a voltage-dividing resistor pair connected in series between first and second output terminals;
a main driver stage comprising first and second current sources, a first PMOS transistor connected in series between the first current source and the first output terminal, a second PMOS transistor connected in series between the first current source and the second output terminal, a first NMOS transistor connected in series between the first output terminal and the second current source, and a second NMOS transistor connected in series between the second output terminal and the second current source; and
a post driver stage comprising third and fourth current sources, a third PMOS transistor connected in series between the third current source and the first output terminal, a fourth PMOS transistor connected in series between the third current source and the second output terminal, a third NMOS transistor connected in series between the first output terminal and the fourth current source, and a fourth NMOS transistor connected in series between the second output terminal and the fourth current source;
wherein the main and post driver stages are the only driver stages connected to the output terminals.

9. The circuitry defined in claim 8 wherein a bulk of at least one of the PMOS transistors is connected to a power supply voltage of the transmitter driver circuitry.

10. The circuitry defined in claim 8 further comprising:
circuitry for applying a serial data signal to a gate of the first PMOS transistor and a gate of the first NMOS transistor;
circuitry for applying a complement of the serial data signal to a gate of the second PMOS transistor and a gate of the second NMOS transistor;
circuitry for applying a delayed and inverted version of the serial data signal to a gate of the third PMOS transistor and a gate of the third NMOS transistor; and
circuitry for applying a complement of the delayed and inverted version to a gate of the fourth PMOS transistor and a gate of the fourth NMOS transistor.

11. The circuitry defined in claim 8 wherein the first current source is connected in series between a power supply voltage of the transmitter driver circuitry and the first and second PMOS transistors, wherein the second current source is connected in series between the first and second NMOS transistors and a ground voltage supply of the transmitter driver circuitry, wherein the third current source is connected in series between the power supply voltage and the third and fourth PMOS transistors, and wherein the fourth current source is connected in series between the third and fourth NMOS transistors and the ground voltage supply.

12. The circuitry defined in claim 9 wherein at least one of the first, second, third, and fourth current sources is of controllably variable strength.

13. The circuitry defined in claim 8 wherein a node that is intermediate the resistor pair is connected to a ground voltage supply of the transmitter driver circuitry.

14. The circuitry defined in claim 9 wherein the bulk of the at least one of the PMOS transistors is an N-well of the transmitter driver circuitry.

15. The circuitry defined in claim 8 wherein a bulk of at least one of the NMOS transistors is connected to a ground voltage supply of the transmitter driver circuitry.

16. The circuitry defined in claim 15 wherein the bulk of the at least one of the NMOS transistors is a P-well of the transmitter driver circuitry.

17. Transmitter driver circuitry for outputting a high speed serial data signal comprising:
a main H-tree driver stage connected to a pair of differential output terminals, a voltage-dividing resistor pair being connected between said terminals; and
a post-tap H-tree driver stage connected in parallel with the main H-tree driver stage to said terminal, said main and post-tap H-tree driver stages being the only driver stages connected to said terminals.
